(19) United States
(12) Patent Application Publication
(10) Pub. No.: US 2006/0164413 A1
(43) Pub. Date: Jul. 27, 2006

(54) Computer-implemented geometric shape interaction process

(76) Inventor: David Colbert, Cornwall Bridge, CT (US)

Correspondence Address: Brian M. Dingman, Esq.;Mirick, O'Connell, DeMallie & Lougee, LLP, 1700 West Park Drive, Westborough, MA, 01581, US

(21) Appl. No.: 11/337,909

(22) Filed: Jan. 23, 2006

Related U.S. Application Data
(60) Provisional application No. 60/646,273, filed on Jan. 24, 2005.

(51) Int. Cl. G06T 17/00

(52) U.S. Cl. 345/420

(57) ABSTRACT

A computer-based method of creating displays of a number of different geometric shapes that are displayed on the computer display. Display limitations that retain predetermined orientations of at least two of the geometric shapes are defined, and the user is allowed to manipulate the display of the geometric shapes, but subject to the defined display limitations.

### CROSS REFERENCE TO RELATED APPLICATION

This application claims priority of provisional application Ser. No. 60/646,273, filed on Jan. 24, 2005.

### FIELD OF THE INVENTION

The present invention relates to a computer-implemented game based on geometric shape manipulation.

### BACKGROUND OF THE INVENTION

The sphere and the five regular or “Platonic” (so named because Plato used them to help explain the origin of the universe) solids have been known for at least 2500 years. Their attraction, as primary forms, is timeless. In our time, the computer can shed new light on these basic forms, giving us a new freedom to play with form and space, anchored in basic solid geometry.

### SUMMARY OF THE INVENTION

The invention comprises a space dividing process and system based on geometric shapes, including the Platonic Solids and the sphere. When these forms are nested, overlapping fully or partially with one another, multitudes of harmonious spatial relationships are revealed. If one extends one's interest beyond the forms themselves to the forms as generators of these spatial relationships, a space dividing methodology of great plasticity is produced.

Imagine building blocks which are primary forms but which, before the computer, were too difficult to create and manipulate for the casual user. Computers now provide the opportunity to facilitate a new and fun way to experiment with spatial mathematics. Among the possible uses of the invention are: interactive exhibits at science museums; art/science projects at schools; or home-based computer games.

This invention features a computer-based method of creating displays of a number of different geometric shapes that are displayed on the computer display. Display limitations that retain predetermined orientations of at least two of the geometric shapes are defined, and the user is allowed to manipulate the display of the geometric shapes, but subject to the defined display limitations. The shapes preferably comprise one or more of the Platonic solids, more preferably all of them, and may further include the sphere.

One display limitation may be that one or more of the shapes retain a defined orientation relative to at least one of the three following planes: those defined by the xy, xz and yz axes. The defined orientation may be that one or more shapes remain parallel to a plane. In one embodiment, a limitation is that each of the reference planes corresponding to the xy, xz, and yz axis for each platonic solid remain parallel to the xy, xz, and yz axis, respectively. The method may further comprise allowing the user to select a quantity and scale of any one or all of the geometric shapes, a degree of transparency of any one or all of the geometric shapes, whether to display some or all of any geometric shape, and allowing the user to display the shapes as solids, surfaces or lines. The method may further comprise allowing the user to move the shapes so that they may intersect one another. The user may be allowed to link together two or more shapes such that the linked shapes move together.

In another embodiment, the invention features a computer-based method of creating displays comprising a plurality of geometric shapes which include the Platonic solids and the sphere and that are displayed on the computer display, the method comprising defining display limitations that retain predetermined orientations of the geometric shapes, the limitations comprising requiring that each of the reference planes corresponding to the xy, xz and yz axis for each of the platonic solids remain parallel to the xy, xz and yz axis, respectively, allowing the user to display the shapes as solids, surfaces or lines, and allowing the user to move the shapes so that they may intersect one another, and allowing a user to manipulate the display of the geometric shapes, but subject to the defined display limitations.

### BRIEF DESCRIPTION OF THE DRAWINGS

Other objects, features and advantages will occur to those skilled in the art from the following description of the preferred embodiments and the accompanying drawings, in which:

FIG. 1 shows the geometric shapes used in one preferred embodiment of the invention;

FIG. 2 shows a cube with the vertices and side midpoints labeled for a better understanding of the invention;

FIG. 3 shows an octahedron with the vertices labeled for a better understanding of the invention;

FIG. 4 shows a dodecahedron with the vertices labeled for a better understanding of the invention;

FIG. 5 shows a tetrahedron with the vertices and side midpoints labeled for a better understanding of the invention;

FIG. 6 shows an icosahedron with the vertices labeled for a better understanding of the invention;

FIG. 7 is a representation of the quantity and scale of the shapes, useful for a better understanding of the invention;

FIGS. 8A-D shows four of the essentially innumerable displays accomplished by the invention; and

FIG. 9 are simple line drawings of the shapes shown in FIG. 1.

### DETAILED DESCRIPTION OF THE INVENTION

The invention may be accomplished using a properly programmed computer, as more fully described below.

### How to Make the Preferred Embodiment of the Invention

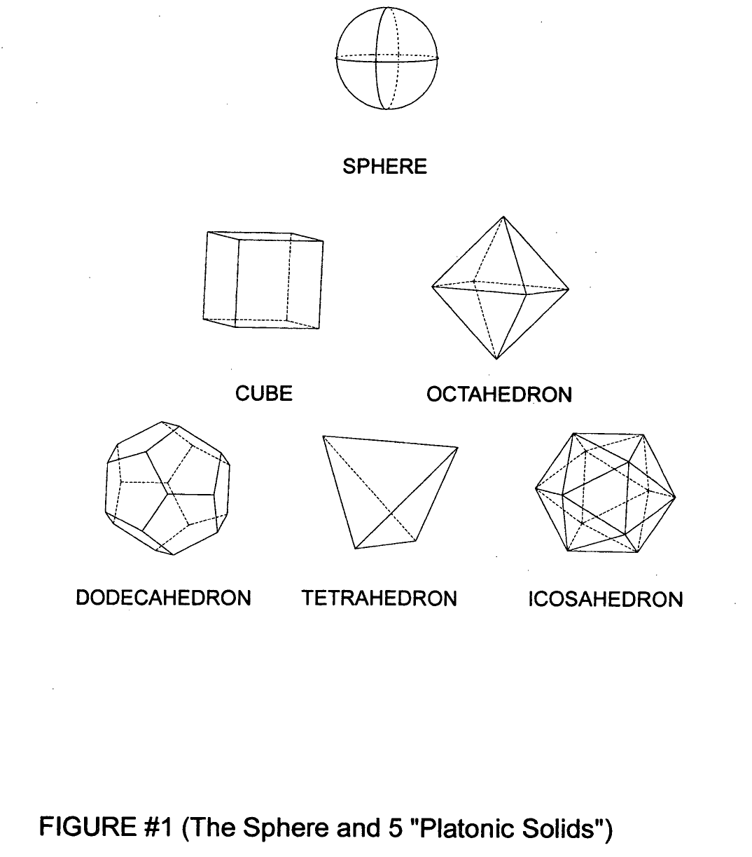

Create geometric shapes using a three dimensional capable computer software running on a standard PC, for example: “SolidWorks”, by SolidWorks Corporation. In the preferred embodiment, the shapes are the five “Platonic Solids” and the sphere, all shown in FIG. 1.

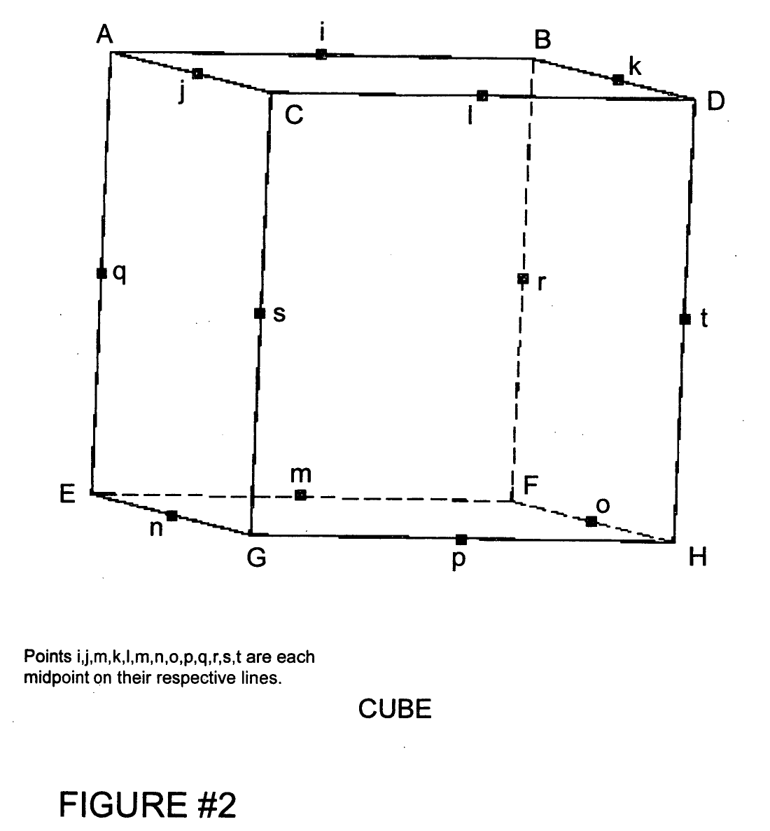

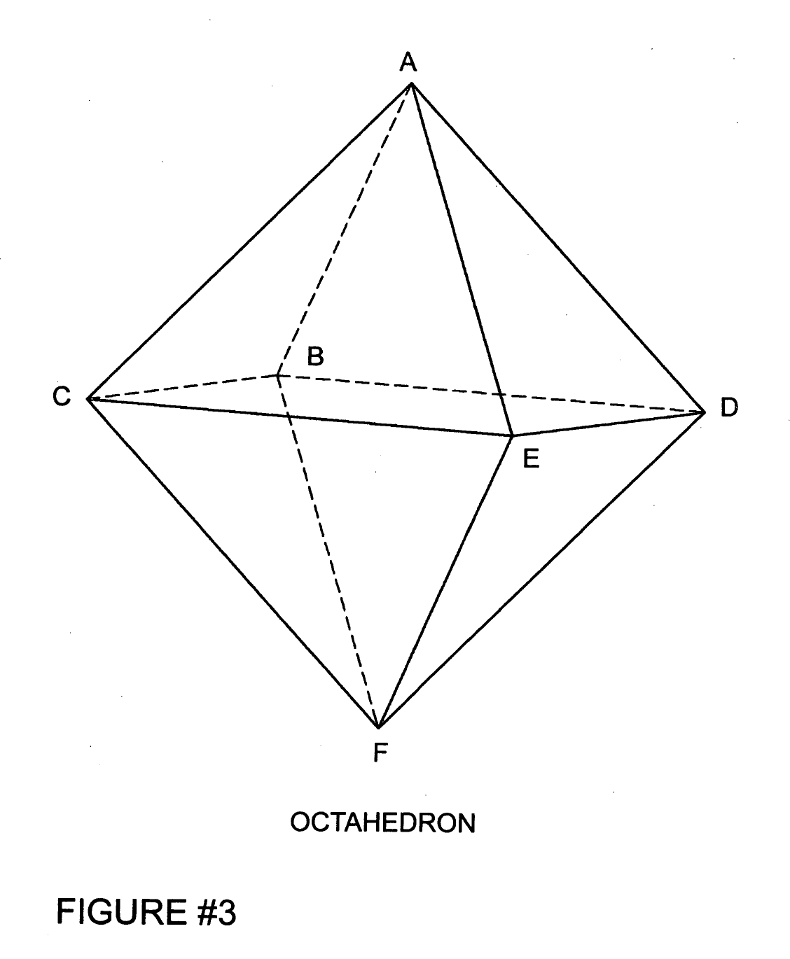

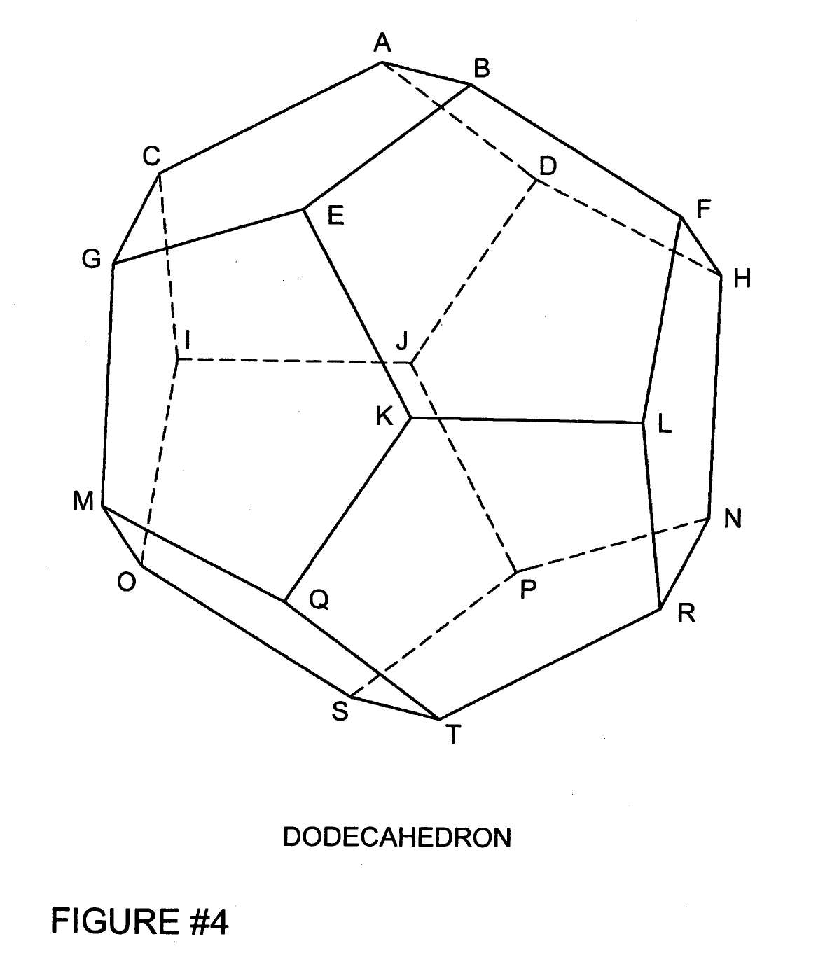

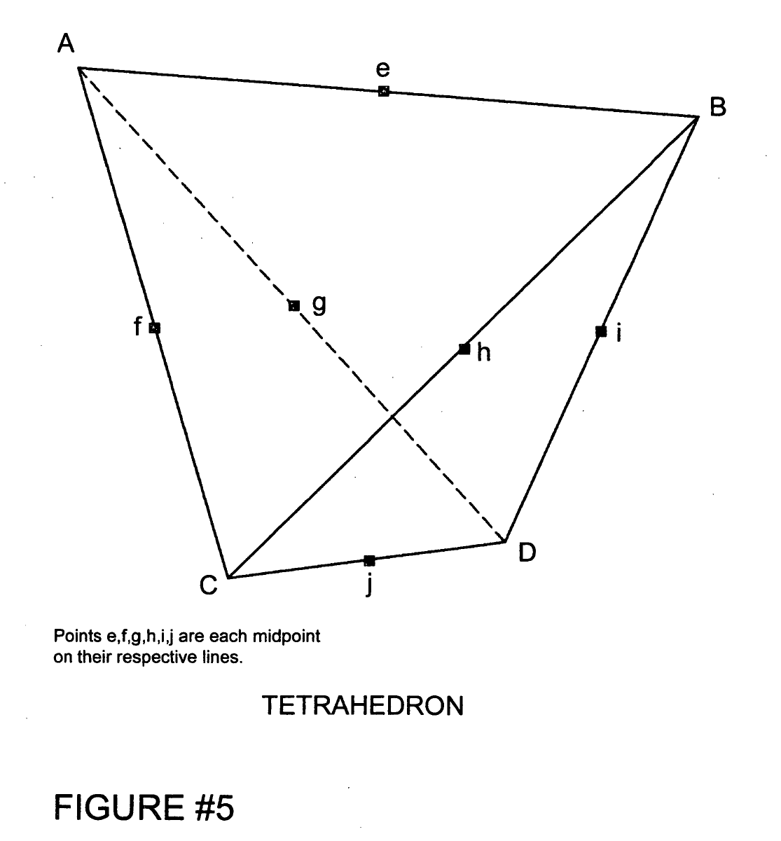

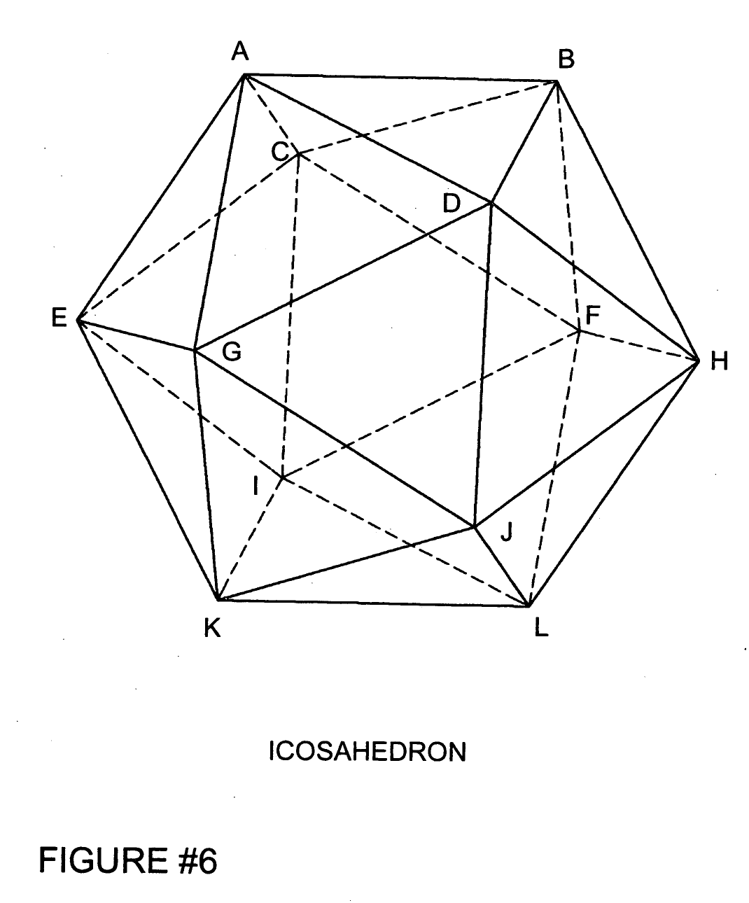

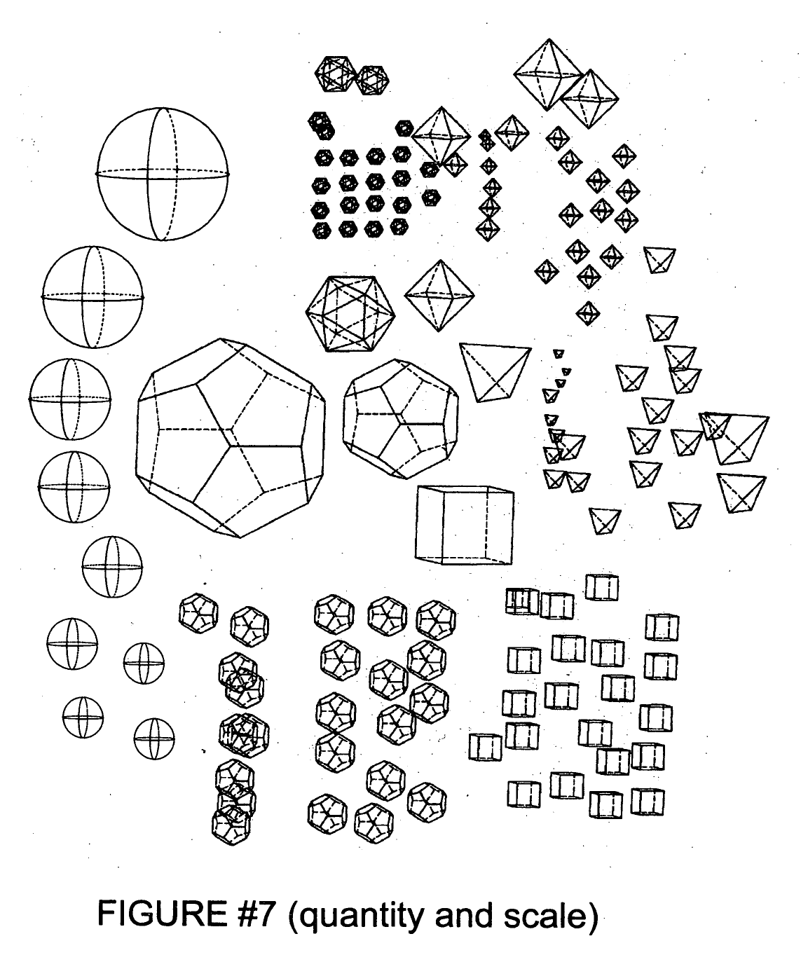

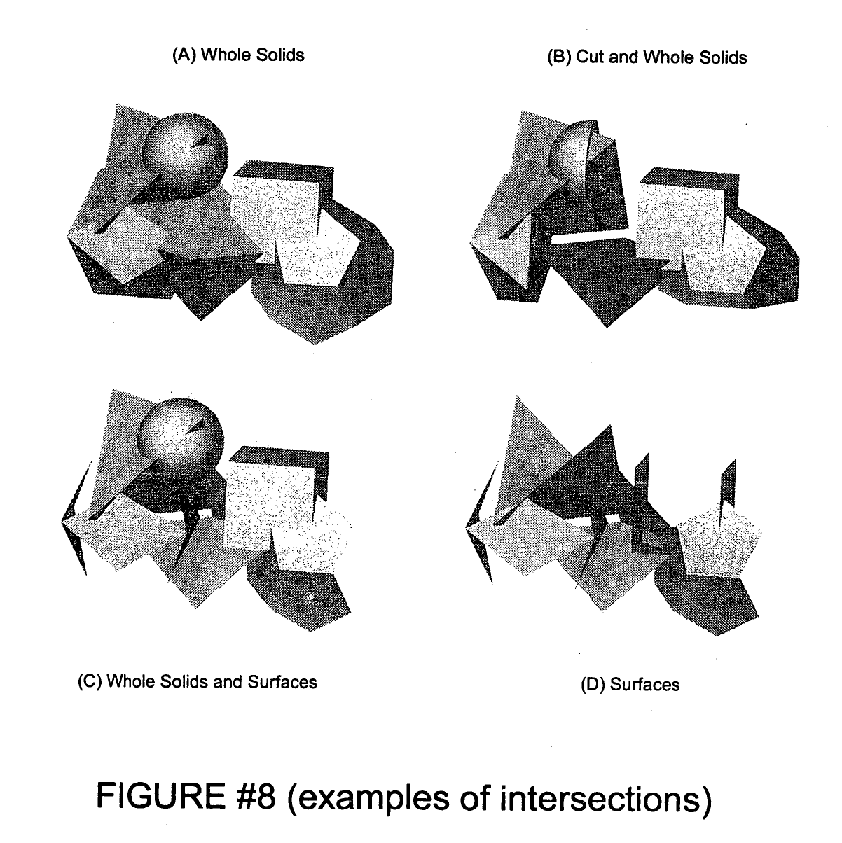

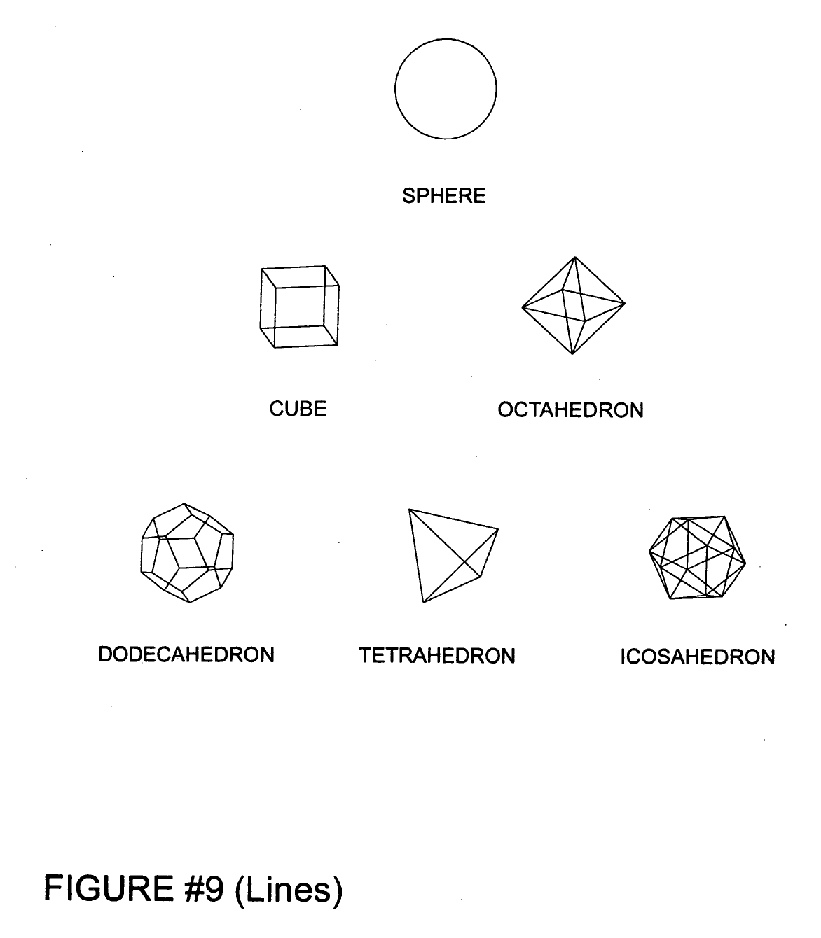

Insert design parameters so that each of the Platonic Solids retains a particular orientation to the others (the sphere, being omni directional, requires no orientation parameters). These parameters are then employed as the invention as used. In the preferred embodiments, the following are the parameters that must be adhered to as the invention is used. These parameters can be programmed into the PC running the described software:
Each of the “Platonic Solids” has three mutually orthogonal reference planes defined for it. These reference planes are used to establish the allowed orientation(s) of the forms. See FIGS. 2-6 for the reference planes. Note that in these Figures, labels are applied to each of the vertices and in some cases the midpoints of the sides of the shapes. Table 1 indicates which planes of which forms must remain parallel to the planes defined by the xy, xz and yz axes in the preferred embodiment of the invention. Also, in the preferred embodiment the tetrahedron will have either the (A) or (B) orientation.
The forms are free of limitations with regard to scale and quantity (see FIG. 7).
The forms can have any degree of transparency, shininess, or color.
The forms can appear as solids (FIG. 8a), surfaces (FIG. 8d), or lines (FIG. 9).
The forms can be cut, or divided (FIG. 8b) such that any part or all of a form can be displayed.
Regardless of how they appear, as indicated in items above, the forms can be moved at will so that they may intersect one another (FIGS. 8A-D).
The forms can be “linked” to one another, or “unlinked”. The individual forms of such linked forms then may not be moved independently of one another.

The linked forms, portions of forms or groups of forms are then capable of movement, rotation, shrinkage, enlargement, or animation.

TABLE 1

| | | | Reference |
|---|---|---|---|
| | Form | FIG. # | Plane |
| Parallel to X-Y Plane | Cube | 2 | jkon |
| | Octahedron | 3 | ADFC |
| | Dodecahedron | 4 | GHNM |
| | Tetrahedron | 5 | (A) eijf, or |
| | | | (B) ehjg |
| | Icosahedron | 6 | ABLK |
| Parallel to Y-Z Plane | Cube | 2 | ilpm |
| | Octahedron | 3 | AEFB |
| | Dodecahedron | 4 | ABTS |
| | Tetrahedron | 5 | (A) ehjg or |
| | | | (B) eijf |
| | Icosahedron | 6 | CDJI |
| Parallel to X-Z Plane | Cube | 2 | rtsq |
| | Octahedron | 3 | BDEC |
| | Dodecahedron | 4 | IJLK |
| | Tetrahedron | 5 | (A) gihf, or |
| | | | (B) same(gihf) |
| | Icosahedron | 6 | FHGE |

### How to Use the Invention

Begin with any number of the above-mentioned solids, surfaces, lines, or portions thereof. Move individual or linked forms to create assemblages of forms. Play with them, as described above. An example of a computer program that provides this functionality is “edrawings”, by Solidworks Corporation. Create designs free of utility, or model environments, cities, space stations, etc.

Although specific features of the invention are shown in some drawings and not others, this is for convenience only as the features may be combined in other fashions in accordance with the invention.

Other embodiments will occur to those skilled in the art and are within the following claims.

What is claimed is:

1. A computer-based method of creating displays comprising a plurality of geometric shapes that are displayed on the computer display, the method comprising:
defining display limitations that retain predetermined orientations for at least two of the geometric shapes; and
allowing a user to manipulate the display of the geometric shapes, but subject to the defined display limitations.

2. The method of claim 1 wherein the shapes comprise one or more of the Platonic solids.

3. The method of claim 2 wherein the shapes comprise all of the Platonic solids.

4. The method of claim 3 wherein the shapes further comprise the sphere.

5. The method of claim 2 wherein a limitation is that one or more of the shapes retain a defined orientation relative to the planes defined by the xy, xz and yz axes.

6. The method of claim 5 wherein the limitation is that one or more of the shapes retain a defined orientation relative to the planes defined by the xy, xz and yz axes comprises requiring that each of the reference planes corresponding to the xy, xz, and yz axis for each platonic solid remain parallel to the planes defined by the xy, xz, and yz axes.

7. The method of claim 1 further comprising allowing the user to select a quantity and scale of any one or all of the geometric shapes.

8. The method of claim 1 further comprising allowing the user to select a degree of transparency of any one or all of the geometric shapes.

9. The method of claim 1 further comprising allowing the user to select whether to display some or all of any geometric shape.

10. The method of claim 9 wherein allowing the user to select whether to display some or all of any geometric shape comprises allowing the user to display the shapes as solids, surfaces or lines.

11. The method of claim 1 wherein allowing the user to manipulate the display comprises allowing the user to move the shapes so that they may intersect one another.

12. The method of claim 1 further comprising allowing the user to link together two or more shapes such that the linked shapes move together.

13. A computer-based method of creating displays comprising a plurality of geometric shapes which include the Platonic solids and the sphere and that are displayed on the computer display, the method comprising:
defining display limitations that retain predetermined orientations of the platonic solids, the limitations comprising requiring that each of the reference planes corresponding to the xy, xz, and yz axis for each platonic solid remain parallel to the planes defined by the xy, xz, and yz axes, allowing the user to display the shapes as solids, surfaces or lines, and allowing the user to move the shapes so that they may intersect one another; and
allowing a user to manipulate the display of the geometric shapes, but subject to the defined display limitations.

14. The method of claim 13 further comprising allowing the user to select a quantity and scale of any one or all of the geometric shapes.

15. The method of claim 14 further comprising allowing the user to select a degree of transparency of any one or all of the geometric shapes.

16. The method of claim 15 further comprising allowing the user to select whether to display some or all of any geometric shape.

17. The method of claim 16 further comprising allowing the user to link together two or more shapes such that the linked shapes move together.
